(19) United States
(12) Patent Application Publication
(10) Pub. No.: US 2008/0149410 A1
(43) Pub. Date: Jun. 26, 2008

(54) Arrangement structure of component parts for fuel cell vehicle

(75) Inventors: Dong Soo Yang, Gyeonggi-do (KR); Seng Jong Lyoo, Gyeonggi-do (KR); Hwan Ik Kim, Gyeonggi-do (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 11/983,177

(22) Filed: Nov. 6, 2007

(30) Foreign Application Priority Data
Dec. 14, 2006 (KR) 10-2006-0127953

(51) Int. Cl. B60K 6/32

(52) U.S. Cl. 180/291

(57) ABSTRACT

The present invention provides an arrangement structure of component parts for a fuel cell vehicle that efficiently arranges various component parts of a fuel cell system, a hydrogen supply system and an electric driving system to make the best use of interior space, improve weight distribution of the vehicle, reduce noise, and provide security against a rear-end collision.

The arrangement structure of the present invention includes an engine room, in which a motor 11 and an air blower 12 are mounted on an upper portion of a frame 10, and component parts of an electrical system and a fuel cell system are arranged on an upper portion of the motor 11; an under-floor 20, on which a humidifier 21, a stack 22, a fuel processing system (FPS) box 23, and a hydrogen tank 40 are mounted; seats 29, beneath which electronic parts are arranged on the under-floor 20; and a trunk room, in which a super-capacitor and an initial charging device are mounted.

### CROSS-REFERENCE TO RELATED APPLICATION

This application claims the benefit under 35 U.S.C. §119(a) on Korean Patent Application No. 10-2006-0127953 filed on Dec. 14, 2006, the entire contents of which are incorporated herein by reference.

### BACKGROUND

(a) Technical Field

The present invention relates to an arrangement structure of component parts for a fuel cell vehicle.

(b) Background Art

A fuel cell vehicle is equipped with a fuel cell generation system that generates electric power for driving a motor to operate a vehicle.

In detail, a fuel processing system (FPS) box for supplying hydrogen to a fuel cell, a high-pressure hydrogen tank and the like are mounted in a fuel supply system or hydrogen supply system. A control unit including a motor and a motor controller, a secondary cell such as a battery or a super-capacitor, and the like are arranged in appropriate positions of the electric driving system.

Meanwhile, available spaces for the respective component parts are limited in the vehicle. For example, since the hydrogen is an inflammable gas, it is necessary to provide a layout that prevents the hydrogen from leaking in the vicinity of a high-voltage power line.

Also, for example, in order to prevent a fuel pipe and the high-voltage power line from getting close to each other by a collision of vehicles, the fuel system is positioned in a rear portion of the vehicle and the electric driving system is arranged in a front portion of the vehicle, thus minimizing the possibility of the ignition of leaking hydrogen gas.

U.S. Pat. No. 6,874,588 B2 discloses an arrangement of basic component parts of a fuel cell vehicle and a fuel cell system box, in which a thermoregulator, a fuel cell, a humidifier, and a hydrogen tank are arranged in a row from the front portion of the vehicle as shown in FIG. 1.

However, since the thermoregulator, fuel cell, humidifier, and hydrogen tank are arranged in a row from the front portion of the vehicle, there are dimensional limitations in the longitudinal arrangement of the vehicle and thereby it is difficult to freely arrange the component parts of the vehicle.

Moreover, the above conventional arrangement structure has a problem that the component parts may be easily damaged when a collision accident occurs since the distances between the component parts are too short.

U.S. Patent Publication No. 2006/0024542 A1 discloses a fuel cell vehicle comprising a fuel cell, a fuel cell cooling system, and a coolant pipe including a slope portion extending and sloping continuously upwardly from a horizontal portion.

U.S. Pat. No. 6,994,178 B2 discloses a structure in which a motor is arranged on the upper portion of a frame, a fuel cell is positioned on the upper portion of the motor, and a power control unit is stacked on the upper portion of the fuel cell in the sequential order.

However, since the process of assembling the respective motor, the fuel cell and the power control unit in the sequential order is complicated, the manufacturing cost is increased due to the increase in the number of assembling processes.

The information disclosed in this Background section is only for enhancement of understanding of the background of the invention and should not be taken as an acknowledgement or any form of suggestion that this information forms the prior art that is already known to a person skilled in the art.

### SUMMARY OF THE INVENTION

The present invention has been made in an effort to solve the above problems. One object of the invention is to provide an arrangement structure of component parts for a fuel cell vehicle that efficiently arranges various component parts of a fuel cell system, a hydrogen supply system and an electric driving system, as well as an engine room, an under-floor and a trunk room to make the best use of interior space, improve weight distribution of the vehicle, reduce noise, and provide security against a rear-end collision.

Another object of the present invention is to provide an arrangement structure of component parts for a fuel cell vehicle that eliminates unnecessary interference between the component parts and prevents the component parts from being damaged when a collision accident occurs.

Still another object of the present invention is to provide an arrangement structure of component parts for a fuel cell vehicle that reduces the number of manufacturing processes to improve productivity and earn economic profits.

In a preferred embodiment, the present invention provides an arrangement structure of component parts for a fuel cell vehicle, comprising: an engine room in which a motor and an air blower are mounted on the upper portion of a frame and component parts of an electrical system and a fuel cell system are arranged on the upper portion of the motor; an under-floor on which a humidifier, a stack, a fuel processing system (FPS) box, and a hydrogen tank are mounted; a seat beneath which electronic parts are arranged; and a trunk room in which a super-capacitor and an initial charging device are mounted.

In another preferred embodiment, at least one electronic part is mounted beneath the under-floor.

In still another preferred embodiment, the stack is arranged below the under-floor and mounted on the frame.

In yet another preferred embodiment, the air blower is mounted in a front portion of the motor.

In a further preferred embodiment, component parts of the electrical and the fuel cell systems include a power distribution unit (PDU), a motor control unit (MCU), a high-voltage power distribution (HVPD), an electro-hydraulic power steering (EHPS) system, and a low-voltage DC/DC converter (LDC).

In a still further preferred embodiment, the motor, the air blower, and the component parts of the electrical system and fuel cell systems on the upper portion of the motor may be mounted in the form of a module.

In a yet further preferred embodiment, the motor, the air blower, and the component parts of the electrical system and the fuel cell system on the upper portion of the motor mounted in the engine room, the humidifier, the stack, the FPS box, and the hydrogen tank arranged on the under-floor may be mounted on the frame and assembled integrally with an upper body of the vehicle in a rolling chassis module.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like. The present systems will be particularly useful with a wide variety of motor vehicles.

### BRIEF DESCRIPTION OF THE DRAWINGS

FIG. 1 is a diagram showing a conventional arrangement structure of fuel cell parts;

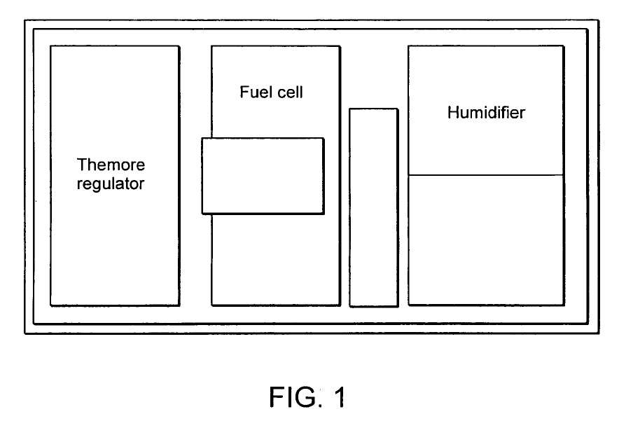

FIG. 2 is a perspective view showing an arrangement structure of an engine room in accordance with a preferred embodiment of the present invention; and

FIG. 3 is a diagram showing an arrangement in which component parts and electronic parts are arranged on an under-floor and in a trunk room of a fuel cell vehicle in accordance with a preferred embodiment of the present invention.

Reference numerals set forth in the Drawings include reference to the following elements as further discussed below:
10: frame
11: motor
12: air blower
20: under-floor
21: humidifier
22: stack
31: super-capacitor
32: initial charging device
40: hydrogen tank

### DETAILED DESCRIPTION

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

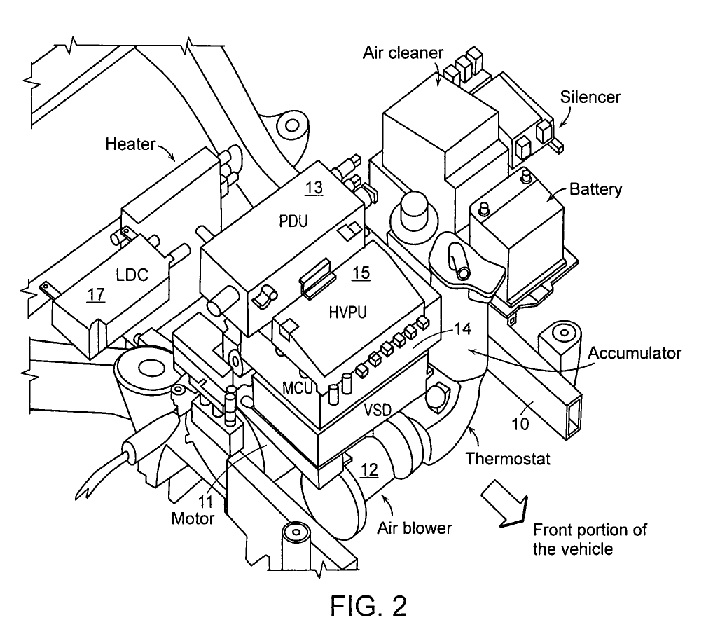

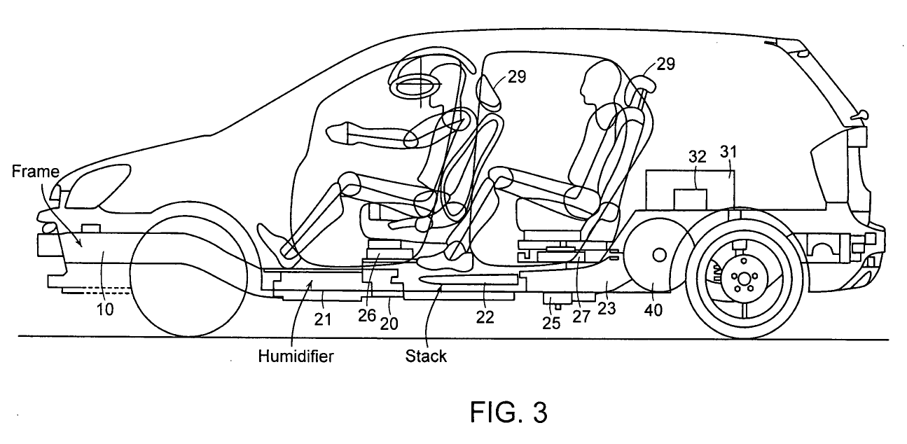

With reference to FIGS. 2 and 3, in a fuel cell vehicle, a motor 11, an air blower 12, and various component parts of an electrical system and a fuel cell system such as a power distribution unit (PDU) 13, a motor control unit (MCU) 14, a high-voltage power distribution (HVPD) 15, an electro-hydraulic power steering (EHPS) system, a low-voltage DC/DC converter (LDC) 17, and the like are mounted in an engine room.

In the present invention, the motor 11 and the air blower 12 are mounted on the upper portion of a frame 11 using separate mounting members.

Although the MCU 14 and the like may be mounted in an appropriate position of the frame 10 using a mounting member, it is preferable that the MCU 14 and the like are mounted on the upper portion of the motor 11 already mounted on the frame 10 using mounting members such as rubber.

Moreover, it is suitable that the air blower 12 be mounted in a front portion of the motor 11 in order to reduce interior noise of the vehicle.

Meanwhile, electronic parts such as a humidifier 21, a stack 22, a fuel processing system (FPS) box 23 and a hydrogen tank 40 are mounted beneath seats 29 on an under-floor 20.

A super-capacitor and an initial charging device 32 are arranged in a trunk room.

As described above, the present invention more efficiently arranges various component parts and electronic parts, as well as the engine room, the under-floor and the trunk room to make the best use of interior space and freely arrange the component parts of the vehicle.

Moreover, the present invention eliminates unnecessary interference between the component parts, improves productivity by decreasing the number of assembling processes and thereby earns economic profits.

Furthermore, the present invention lowers the center of gravity of the vehicle, improves weight distribution of front and rear wheels, protects the stack in the event of a front-end collision at a low speed, and improves side collision performance by the frame.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An arrangement structure of component parts for a fuel cell vehicle, comprising:
an engine room in which a motor and an air blower are mounted on the upper portion of a frame, and component parts of an electrical system and a fuel cell system are arranged on the upper portion of the motor;
an under-floor on which a humidifier, a stack, a fuel processing system (FPS) box, and a hydrogen tank are mounted;
a seat beneath which electronic parts are arranged; and
a trunk room in which a super-capacitor and an initial charging device are mounted.

2. The arrangement structure of claim 1, wherein at least one electronic part is mounted beneath the under-floor.

3. The arrangement structure of claim 1, wherein the stack is arranged below the under-floor and mounted on the frame.

4. The arrangement structure of claim 1, wherein the air blower is mounted in a front portion of the motor.

5. The arrangement structure of claim 1, wherein the component parts of the electrical system and the fuel cell system include a power distribution unit (PDU), a motor control unit (MCU), a high-voltage power distribution (HVPD), an electro-hydraulic power steering (EHPS) system, and a low-voltage DC/DC converter (LDC).

6. The arrangement structure of claim 1, wherein the motor, the air blower, and the component parts of the electrical system and the fuel cell system on the upper portion of the motor are mounted in the form of a module.

7. The arrangement structure of claim 1, wherein the motor, the air blower, and the component parts of the electrical system and the fuel cell system on the upper portion of the motor mounted in the engine room, the humidifier, the stack, the FPS box, and the hydrogen tank arranged on the under-floor are mounted on the frame and assembled integrally with an upper body of the vehicle in a rolling chassis module.
